(19) United States
(12) Patent Application Publication
(10) Pub. No.: US 2026/0330319 A1
(43) Pub. Date: Oct. 22, 2026

(54) AGENT TRAINING METHOD AND AGENT

(71) Applicant: BEIJING BAIDU NETCOM SCIENCE TECHNOLOGY CO., LTD., Beijing (CN)

(72) Inventors: Le ZHANG, Beijing (CN); Jingbo ZHOU, Beijing (CN); Hua WU, Beijing (CN)

(73) Assignee: BEIJING BAIDU NETCOM SCIENCE TECHNOLOGY CO., LTD., Beijing (CN)

(21) Appl. No.: 19/704,268

(22) Filed: Jun. 10, 2026

(30) Foreign Application Priority Data
Mar. 18, 2026 (CN) 202610336238.4

(51) Int. Cl. G06N 20/00

(52) U.S. Cl. CPC G06N 20/00

(57) ABSTRACT

An agent training method relating to the field of artificial intelligence technology, and in particular to the technical fields of GUI, agent, large model, etc, is provided. The agent training method includes: acquiring a trajectory sample of a target task, the trajectory sample including samples of a plurality of steps, each sample of a step including: a GUI environment state and a GUI interaction action; determining a starting step among the plurality of steps, where the starting step and a current iteration number are in an inverse mapping relationship; acquiring, from the GUI environment states, a starting state corresponding to the starting step, and generating a prompt based on the starting state; processing the prompt using an agent to obtain a truncated trajectory corresponding to the starting state; and adjusting model parameters based on the truncated trajectory.

### CROSS-REFERENCE TO RELATED APPLICATION

The present disclosure claims the priority and benefit of Chinese Patent Application No. 202610336238.4, filed on Mar. 18, 2026, entitled “Agent training and task processing method, apparatus, agent and related product”. The disclosure of the above application is incorporated herein by reference in its entirety.

### TECHNICAL FIELD

The present disclosure relates to the field of artificial intelligence technology, and in particular to the technical fields of Graphical User Interface (GUI), agent, large model, etc., and specifically relates to an agent training method, an agent and a device.

### BACKGROUND

In a Graphical User Interface (GUI) scenario, a GUI agent may be used to complete a GUI task.

### SUMMARY

The present disclosure provides an agent training method, an agent and a device.

According to one aspect of the present disclosure, an agent training method is provided, including: acquiring a trajectory sample of a target task, the trajectory sample including samples of a plurality of steps, each sample of a step including: a GUI environment state and a GUI interaction action; determining a starting step among the plurality of steps, where the starting step and a current iteration number are in an inverse mapping relationship; acquiring, from the GUI environment states, a starting state corresponding to the starting step, and generating a prompt based on the starting state; processing the prompt using an agent to obtain a truncated trajectory corresponding to the starting state; and executing, based on the truncated trajectory, a model parameter adjustment process of the agent for the current iteration number.

According to another aspect of the present disclosure, an agent is provided, including: an input module configured to acquire a GUI task; a processing module configured to process the GUI task to obtain a task processing result; an output module configured to output the task processing result; where the agent is trained using the method described above.

According to another aspect of the present disclosure, an electronic device is provided, including: at least one processor; and a memory communicatively connected to the at least one processor; where the memory stores instructions executable by the at least one processor, the instructions being executed by the at least one processor to enable the at least one processor to perform the method of any one of the above aspects.

It should be understood that the content described in this section is not intended to identify key or important features of the embodiments of the present disclosure, nor is it intended to limit the scope of the present disclosure. Other features of the present disclosure will become easily understood from the following description.

### BRIEF DESCRIPTION OF THE DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram of an architecture composition during an agent training phase according to an embodiment of the present disclosure;

FIG. 4 is a schematic diagram according to a third embodiment of the present disclosure;

FIG. 5 is a schematic diagram according to a fourth embodiment of the present disclosure;

FIG. 6 is a schematic diagram according to a fifth embodiment of the present disclosure;

FIG. 7 is a schematic diagram according to a sixth embodiment of the present disclosure; and

FIG. 8 is a schematic diagram of an electronic device for implementing an agent training method or an agent-based task processing method according to an embodiment of the present disclosure.

### DETAILED DESCRIPTION OF EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

To better understand the present disclosure, related terms are explained as follows:

A Graphical User Interface (GUI), also known as a graphical user interface, refers to a computer operation user interface displayed in a graphical manner.

An agent refers to an entity capable of perceiving an environment and autonomously taking actions to achieve specific goals. It can be software, hardware, or a system. An agent is not merely a simple tool, but an intelligent subject that can actively adapt to an environment, learn, and optimize strategies. The current development of agents uses a large model, such as a Large Language Model (LLM), as a core intelligent foundation, and their architecture typically includes modules such as memory, planning, tool use, and action execution.

A Large Language Model (LLM) is a deep learning model trained on a large amount of text data, capable of generating natural language text or understanding the meaning of language text, with a parameter scale usually reaching billions to trillions. An LLM can perform operations based on a prompt.

A prompt is a text instruction input by a user to an LLM, used to guide a model to generate specific, accurate, or expected output. It is the core way for humans to interact with large models and determines the direction in which the model understands tasks and generates content. It may specifically include a Task, used to clearly tell the model what to do; Context, used to provide relevant information to help the model understand a scenario or conditions in which a task occurs; an Example, used to indicate an expected format or style of input and output; and a Role, used to indicate an identity the model should play.

A GUI agent is an artificial intelligence system capable of understanding natural language instructions, perceiving GUI information, and automatically performing operations (such as clicking, inputting) to complete tasks. It mainly operates on GUI interfaces of desktop operating systems (e.g., Windows, Ubuntu) or desktop-level applications, relying on visual/structured information such as screen shots and interface element coordinates to perceive an environment. By traversing interface corners and accumulating GUI interaction sequences, it achieves functions such as task mining (e.g., automatically generating software operation procedures), interface testing (e.g., detecting functional anomalies), or automated office work (e.g., batch processing documents).

A GUI agent is used to process GUI tasks.

A GUI task refers to an operational task completed on a GUI. For example, first opening a browser, then clicking a button in the browser; or, first opening a folder in an operating system, then copying a file in the folder.

A GUI agent may be trained through reinforcement learning, and policy optimization algorithms for reinforcement learning include, for example: Group Relative Policy Optimization (GRPO).

In a GUI scenario, an agent interacts directly with a GUI environment, typically using a sparse reward mechanism, i.e., a positive environmental reward (e.g., 1) is given only when the agent completes a final task node (e.g., “successfully placing an order and paying”), while intermediate steps or failed trajectories are given zero reward.

Based on the above sparse reward mechanism, there is a problem that an agent may find it difficult to learn an effective policy. For example, in a GRPO approach, in early training or when introducing difficult tasks (e.g., interactions requiring 20 steps or more), all trajectories sampled within a group may fail, resulting in all rewards being zero. At this point, a variance of an advantage function is zero, a model cannot distinguish which failed trajectory “made fewer mistakes” or “went further”, a gradient is completely lost, leading to training stagnation.

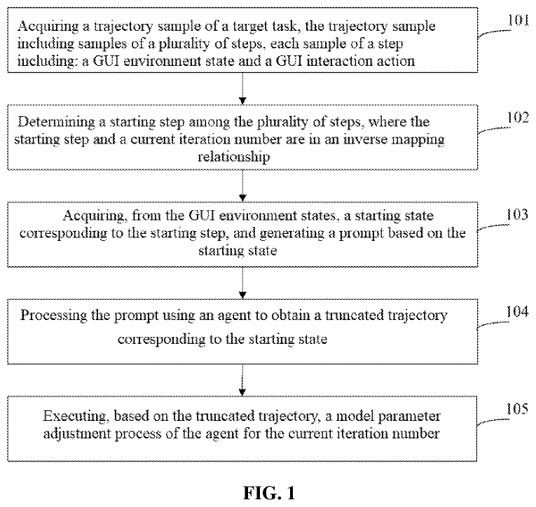

FIG. 1 is a schematic diagram according to a first embodiment of the present disclosure. This embodiment provides an agent training method. As shown in FIG. 1, the method includes:

101, acquiring a trajectory sample of a target task, the trajectory sample including samples of a plurality of steps, each sample of a step including: a GUI environment state and a GUI interaction action.

102, determining a starting step among the plurality of steps, where the starting step and a current iteration number are in an inverse mapping relationship.

103, acquiring, from the GUI environment states, a starting state corresponding to the starting step, and generating a prompt based on the starting state.

104, processing the prompt using an agent to obtain a truncated trajectory corresponding to the starting state.

105, executing, based on the truncated trajectory, a model parameter adjustment process of the agent for the current iteration number.

Here, the method of this embodiment may be applied in a GUI scenario, and the agent mentioned above may specifically be referred to as a GUI agent.

A target task is an existing task used for training. In a GUI scenario, it is specifically a GUI task, such as an operating system interface navigation task, a cross-application graphical interface operation task, or an interface task of a complex software, such as an intelligent guidance module of an office suite or an Enterprise Resource Planning (ERP) system.

A trajectory sample is used to describe an execution process of a target task, including samples of a plurality of steps. Each sample of a step is composed of (s, a), where s represents a state, and a represents an action.

For example, for a target task, if a total number of steps is T (a positive integer greater than 1), then the trajectory sample of the target task includes samples of T steps.

Each sample of a step includes a set of (s, a), i.e., the trajectory sample may be represented as: (s₁, a₁, s₂, a₂, . . . , s_{T}, a_{T}).

In a GUI scenario, samples corresponding to a state s and an action a are respectively: a GUI environment state and a GUI interaction action. The GUI environment state includes, for example: basic interface information (e.g., a currently active window, a page path, etc.), a control state (e.g., whether an input box is clickable, etc.), and/or interface element layout information (e.g., coordinates and sizes of key controls). The GUI interaction action includes, for example: clicking, inputting, and/or pulling down, etc.

The trajectory sample of a target task may be pre-generated through methods such as construction or annotation.

To this end, during training, an existing trajectory sample of a target task may be acquired.

Further, the trajectory sample may be an expert trajectory. An expert trajectory refers to a sequence of states and actions generated by an expert (a human expert or a high-performance agent) when completing a specific task. Since a policy corresponding to an expert trajectory is better, training an agent based on an expert trajectory may yield an agent with better performance.

During a model training process, multiple iteration rounds are typically executed.

A current iteration number t refers to a number corresponding to a currently executed round. For example, a first iteration has an iteration number t=1, a second iteration has an iteration number t=2, etc.

In each iteration round, the agent starts from an exploration starting point and generates an exploration trajectory of one or more steps.

A starting step is a step corresponding to the exploration starting point, which may be denoted as k, where k is greater than or equal to 1 and less than or equal to T.

A starting state refers to a state corresponding to the starting step.

In related art, an agent typically starts exploring from the beginning, i.e., in each iteration round, k is 1 and the starting state is s₁.

In this embodiment, however, the starting step and the current iteration number are in an inverse mapping relationship, instead of being fixed at 1. For example, when the current iteration number t=1, a corresponding starting step is k=T−1; or, when the current iteration number t=2, a corresponding starting step is k=T−3, etc.

After determining a starting step k and its corresponding initial state sₖ, a prompt may be generated based on the initial state sₖ, e.g., including the initial state in the prompt.

A prompt refers to guidance information input into an agent to guide the agent to perform corresponding operations. In this embodiment, the prompt specifically guides the agent to generate a trajectory based on the initial state.

After the prompt is generated, it is input into the agent, and the agent generates a truncated trajectory according to the prompt.

A truncated trajectory refers to an exploration trajectory generated by the agent starting from the starting state, i.e., a trajectory corresponding to the starting step and subsequent steps.

For example, if the starting step is k and the starting state is sₖ, then the truncated trajectory may be represented as: (sₖ′, aₖ′, s₍ₖ₊₁₎′, a₍ₖ₊₁₎′, . . . , s_{T}′, a_{T}′), where, taking (sₖ′, aₖ′) as an example, it represents a state and an action of the k-th step (the starting step) generated by the agent, and the others are similar.

Afterwards, model parameters of the agent are adjusted based on the truncated trajectory, completing a model parameter adjustment for the current iteration number.

For example, based on the truncated trajectory, such as (sₖ′, aₖ′, s₍ₖ₊₁₎′, a₍ₖ₊₁₎′, . . . , s_{T}′, a_{T}′), and a trajectory sample of corresponding steps of the target task, such as (sₖ, aₖ, s₍ₖ₊₁₎, a₍ₖ₊₁₎, . . . , s_{T}, a_{T}), a KL (Kullback-Leibler) divergence is constructed. A reward model is used to calculate a reward value for the truncated trajectory. Then, an advantage value may be calculated based on the KL divergence and the reward value, and then an objective function is calculated based on the advantage value, and the model parameters are adjusted to maximize the objective function, thereby obtaining adjusted model parameters for a current iteration round.

Here, the model parameters may specifically be model parameters of a large model in the agent. The large model is, for example, a Large Language Model (LLM).

In this embodiment, by determining a starting step, and the starting step and a current iteration number are in an inverse mapping relationship, a usual exploration from the beginning can be converted to recursion from a tail. That is, assuming a trajectory has a total of 20 steps, exploration may start from a 19th step in a first iteration round, and from an earlier step, such as a 16th step, in a second iteration round. Thus, in early training, since fewer steps need to be explored, it is easy to obtain an exploration trajectory that succeeds in a task, avoiding problems such as model training stagnation caused by a sparse reward mechanism, facilitating learning of effective policies, improving a reinforcement learning effect of the agent, and thereby improving agent performance, such as increasing a success rate of the agent for GUI tasks.

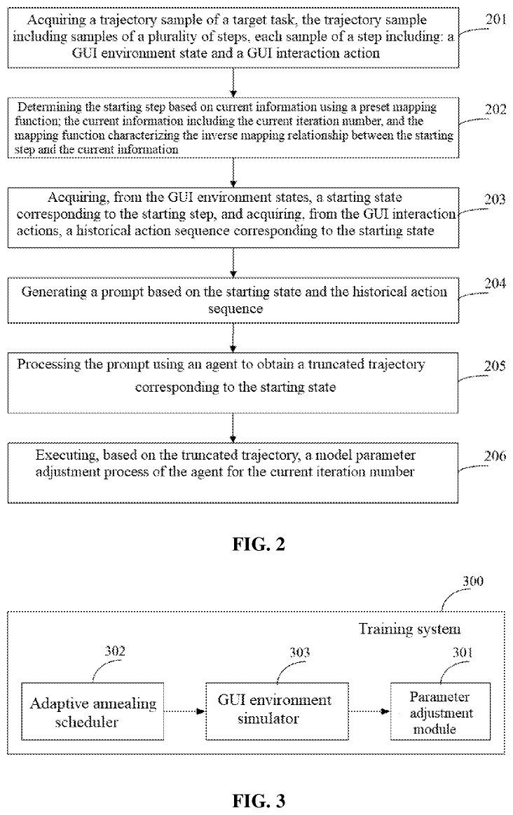

FIG. 2 is a schematic diagram according to a second embodiment of the present disclosure. This embodiment provides an agent training method. This embodiment specifically describes relevant steps.

As shown in FIG. 2, the method includes:

201, acquiring a trajectory sample of a target task, the trajectory sample including samples of a plurality of steps, each sample of a step including: a GUI environment state and a GUI interaction action.

Here, the trajectory sample may be an expert trajectory of a target task. Assuming there are a total of T steps, it is represented as (s₁, a₁, s₂, a₂, . . . , s_{T}, a_{T}), where sₖ, aₖ are a GUI environment state and a GUI interaction action of the k-th step.

202, determining the starting step based on current information using a preset mapping function; the current information including the current iteration number, and the mapping function characterizing the inverse mapping relationship between the starting step and the current information.

Here, the mapping function may be pre-constructed, such as k=f(x), where k is the starting step, x is the current information, and f indicates an inverse mapping relationship between k and x, i.e., a larger x results in a smaller k, and a smaller x results in a larger k. The starting step k may be calculated based on this f(x).

The current information mentioned above includes a current iteration number t. That is, in early training, since t is small, k is large, and exploration can start from a later step among overall task execution steps.

For example, if the total number of steps Tis 20, then when t=1, exploration may start from k=19.

In this embodiment, using the preset mapping function to determine the starting step based on the current information allows for a simple and efficient determination of the starting step.

Further, the current information further includes:
a historical success rate of the target task.

That is, the current information x mentioned above includes not only the current iteration number but also the historical success rate of the target task. Thus, a higher historical success rate corresponds to a smaller starting step, and a lower historical success rate corresponds to a larger starting step. Therefore, for a difficult task (e.g., a task with a low historical success rate), exploration can start from a later step, which facilitates successful exploration.

When the current information includes the current iteration number and the historical success rate of the target task, the starting step may be determined by: determining a negative exponent corresponding to a product of the current iteration number and the historical success rate; determining a starting ratio based on a preset initial ratio and the negative exponent; and determining the starting step based on the starting ratio and a total number of steps of the plurality of steps.

Thus, through the above operations, the starting step may be efficiently determined based on the current iteration number and the historical success rate.

When the current information includes the current iteration number and the historical success rate, a specific calculation formula for the mapping function may be:

pₕᵢₙₜ=pᵢₙᵢₜᵢₐₗ·exp(−γ·t·SRₓ)

k=└T·pₕᵢₙₜ┘

Here, k is the starting step; T is a total number of steps of the trajectory sample; └ ┘ represents rounding down; pₕᵢₙₜ is an intermediate calculation parameter; t is the current iteration number; SRₓ is the historical success rate of the target task; γ, pᵢₙᵢₜᵢₐₗ is a preset value, and pᵢₙᵢₜᵢₐₗ is typically chosen as a value between 0 and 1; exp represents an exponential operation.

The historical success rate of the target task may be determined based on task execution results (success or failure) corresponding to exploration trajectories of historical rounds. In each iteration round, not only an exploration trajectory (specifically a truncated trajectory starting from a starting state) generated by an agent for the target task may be obtained, but also a task execution result (e.g., success or failure) of the exploration trajectory may be obtained. The historical success rate may be obtained based on the task execution results. For example, for a certain iteration round, there are 8 exploration trajectories, and task execution results of 2 of the exploration trajectories are success, i.e., a last action is a preset success action. Then, a success rate of the target task for that iteration round=2/8, which may then serve as the historical success rate for a next iteration round.

In this way, as iterations progress and capabilities of the agent improve, k may gradually decrease from T−1 to 0.

In this embodiment, determining the starting step based on the current iteration number and the historical success rate of the target task enables dynamic determination of the starting step, which is more flexible and accurate; based on the inverse mapping relationship described above, a smooth transition of training difficulty can be achieved, such that as capabilities of the agent improve, a number of steps it needs to explore autonomously can be automatically lengthened, until it can independently complete an entire task from s₁ to s_{T}.

203, acquiring, from the GUI environment states, a starting state corresponding to the starting step, and acquiring, from the GUI interaction actions, a historical action sequence corresponding to the starting state.

Here, assuming the starting step is k, the starting state is sₖ, and a historical action sequence is Hₖ={a₁, a₂, . . . , a₍ₖ₋₁₎}. The starting state and the historical action sequence may be obtained from the aforementioned trajectory sample.

That is, GUI interaction actions of all steps before the starting step may be composed into the historical action sequence.

Thus, when exploring, the agent may refer to the historical action sequence, which provides more historical information for the agent and is beneficial for improving an exploration capability of the agent.

204, generating a prompt based on the starting state and the historical action sequence.

For example, the starting state sₖ and the historical action sequence Hₖ are included in the prompt.

Specifically, the target task, the starting state, and the historical action sequence are added to a prompt template to generate the prompt.

For example, a prompt template may be pre-configured. The template may include fixed content, such as a task instruction instructing generation of an exploration trajectory, and also dynamically fillable content. The dynamically fillable content refers to content that can be filled according to an actual situation, and may specifically include the aforementioned target task, starting state, and historical action sequence. To this end, the above information may be filled into the template to obtain the prompt.

Thus, by pre-configuring the template, the prompt may be generated simply and efficiently.

In this embodiment, by including the starting state and the historical action sequence in the prompt, dual prompting is achieved. By providing the historical action sequence to the agent, exploration steps of the agent in early training can be reduced, allowing the agent to obtain more reference information, effectively alleviating a sparse reward problem caused by long sequence tasks.

205, processing the prompt using an agent to obtain a truncated trajectory corresponding to the starting state.

Here, after the prompt is generated, it is input into the agent. The agent executes the target task according to the prompt and outputs a corresponding truncated trajectory. For example, the prompt includes not only the target task, the starting state, and the historical action sequence, but may also include a preset instruction (such as fixed content configured in a prompt template), e.g., instructing the agent to generate a trajectory. Thus, the agent may generate a truncated trajectory based on the prompt.

A truncated trajectory refers to an exploration trajectory generated by the agent starting from the starting state, i.e., a trajectory corresponding to the starting step and subsequent steps.

Specifically, the truncated trajectory includes: trajectory points between the starting step and a terminal step, the trajectory points including: a predicted state and a predicted action.

For example, if the starting step is k and the starting state is sₖ, then the truncated trajectory may be represented as: (sₖ′, aₖ′, s₍ₖ₊₁₎′, a₍ₖ₊₁₎, . . . , s_{T}′, a_{T}′), where, taking (sₖ′, aₖ′) as an example, it represents a predicted state and a predicted action of a k-th step (the starting step) corresponding to the agent, and the others are similar. Here, a predicted action of each step may be a GUI interaction action generated by the agent, and a predicted state of each step may be provided by another service module. For example, after the agent performs an action, another service may capture a screenshot of a GUI to obtain a corresponding GUI environment state as the predicted state.

Further, the truncated trajectory may be multiple, such as multiple trajectories within a group of GRPO, so that model parameter adjustment may be performed using a GRPO method.

Here, the agent may be used to control a plurality of environment replicas in parallel based on the prompt, so as to generate a plurality of truncated trajectories in parallel in the plurality of environment replicas.

For example, G (a positive integer greater than 1) environment replicas may be controlled in parallel, so that the agent can generate G truncated trajectories in parallel based on a same prompt. By generating multiple truncated trajectories in parallel, processing efficiency can be improved.

206, executing, based on the truncated trajectory, a model parameter adjustment process of the agent for the current iteration number.

Here, an objective function may be constructed based on the truncated trajectory; and model parameters are adjusted based on the objective function.

For example, after constructing the objective function, the model parameters are adjusted to maximize the objective function.

The objective function is constructed based on the truncated trajectory. Specifically, an error loss may be constructed based on the truncated trajectory and the trajectory sample; a credit value may be acquired based on the error loss; and the objective function may be constructed based on the credit value.

For example, an error loss (such as a KL divergence) may be constructed according to the truncated trajectory and a trajectory of corresponding steps in the trajectory sample, i.e., a KL (Kullback-Leibler) divergence is constructed according to (sₖ′, aₖ′, s₍ₖ₊₁₎′, a₍ₖ₊₁₎′, . . . , s_{T}′, a_{T}′) and (sₖ, aₖ, s₍ₖ₊₁₎, a₍ₖ₊₁₎, . . . , s_{T}, a_{T}). Then, a credit value is acquired based on the KL divergence, and an objective function is constructed according to the credit value.

Here, the credit value may be an advantage value obtained based on a Proximal Policy Optimization (PPO) algorithm or a GRPO algorithm.

Thus, through the above objective function, the agent can be facilitated to learn more effective policies.

By using an advantage value obtained based on a PPO algorithm or a GRPO algorithm, the PPO algorithm or the GRPO algorithm may be used for reinforcement learning of the agent.

Taking a PPO algorithm as an example, a formula for the objective function may be:

$$L ( θ ) = E [ min ( \frac{{π}_{θ} ( {a}_{k} \vert {s}_{k} )}{{π}_{old} ( {a}_{k} \vert {s}_{k} )} {A}_{k} , clip ( \frac{{π}_{θ} ( {a}_{k} \vert {s}_{k} )}{{π}_{old} ( {a}_{k} \vert {s}_{k} )} , 1 - ε , 1 + ε ) {A}_{k} ) ]$$

Here, L(θ) is the objective function;
π_{θ} represents a model after adjustment (e.g., a large model in the agent), and θ is its model parameter; π_{old} represents a model before adjustment;

$$\frac{{π}_{θ} ( {a}_{k} \vert {s}_{k} )}{{π}_{old} ( {a}_{k} \vert {s}_{k} )}$$

is an importance sampling ratio, representing a ratio of action probabilities between a new policy and an old policy;
aₖ, sₖ are an action and a state of a k-th step, respectively;
Aₖ is an advantage value of the k-th step, which is calculated according to a KL divergence;
clip is a clipping function, ε is a preset clipping threshold;
min is a minimum value operation;
E is an expected value operation. Specifically, for a current iteration round, a mean value of related data calculated based on the above formula for all steps of all exploration trajectories in the current iteration round may be used as the expected value.

After constructing the above objective function, model parameter adjustment may be achieved by maximizing the above objective function.

Additionally, for a GRPO algorithm, the GRPO algorithm generates a set of truncated trajectories. For example, after generating G truncated trajectories, model parameters may be adjusted based on an expert trajectory of the target task and the above G trajectories using a GRPO method.

Specifically, after determining a starting state sₖ, a system may launch G GUI environment replicas in parallel. Based on a same starting state sₖ and an action prefix Hₖ, a large model independently samples G truncated trajectories {sₖ′, aₖ′, . . . s_{T}′, a_{T}′} that complete to an end.

In early training, since a starting point is very close to a target (e.g., a second-to-last step), the G trajectories will contain both successful (Reward=1) and failed (Reward=0) samples. The system calculates intra-group returns and normalizes them, and applies a GRPO formula to update model parameters.

In related art, in early stages of complex GUI tasks, G trajectories in a group in traditional GRPO very easily all yield zero rewards, causing an advantage function to be incalculable.

In this embodiment, based on the inverse mapping relationship and multiple truncated trajectories described above, a high success rate interval can be actively constructed, thereby completely breaking a “reward collapse” dilemma and forcibly creating reward variance within the group. This allows a GRPO algorithm to obtain clear gradient directions (i.e., knowing which small action differences at a current truncation point determine final success or failure) at any stage of training, achieving efficient credit assignment for key actions and improving training effectiveness.

Additionally, in terms of a specific architecture, FIG. 3 is a schematic diagram of an architecture composition during an agent training phase according to an embodiment of the present disclosure.

As shown in FIG. 3, compared to a typical training method, during a training phase, a training system 300 introduces an adaptive annealing scheduler 302 and a GUI environment simulator 303 in addition to a model parameter adjustment module 301. The adaptive annealing scheduler is used to determine a starting step, such as calculating a starting step k according to the above mapping function. The GUI environment simulator jumps to a starting state sₖ corresponding to the starting step k. Traditional reinforcement learning starts exploration fixedly from s₁. In this embodiment, the GUI environment simulator can dynamically and flexibly switch to any required starting state, and when multiple truncated trajectories need to be generated, it can also construct multiple GUI environment replicas, thereby obtaining G truncated trajectories from any starting state. The model parameter adjustment module 301 adjusts model parameters according to the G truncated trajectories.

In this embodiment, based on the GUI environment simulator, a physical environment foundation is provided for subsequently inputting a prompt into an agent, ensuring that after the agent receives the prompt, it can continue executing actions under its corresponding real GUI screen shot and system state.

A specific GUI task is used below to illustrate the above training process:

Target GUI task: a complex cross-application operation and general-purpose GUI control system task.

Application scenario description: When building a general-purpose GUI operation agent that supports multi-modal input and can handle high-complexity daily office and professional tasks, a system typically needs an ability to perform continuous operations across web pages and local applications. For example, a task is “extract an invoice amount from a local email client, then open a browser to log into a company ERP system to complete a reimbursement application”. Such tasks may have dozens of steps, and conventional reinforcement learning exploration very easily fails at early steps (e.g., login verification), making it impossible for a model to learn subsequent key business logic.

Based on the above training method, a process includes:
(1) Expert trajectory loading and environment fast-forwarding: A system first parses an expert trajectory of a reimbursement task. In early training, a simulator environment does not start from “opening email”, but directly uses a snapshot technology to “fast-forward” an operating system state to a “final submission page” of an ERP system (e.g., a 20th step of the task), while converting historical actions of first 19 steps into a historical action sequence to be input into a large model in an agent.
(2) Reverse curriculum learning: The agent only needs to learn to click a “confirm submission” button to obtain a positive reward. As a success rate (SRₓ) of the agent on this truncated task reaches a threshold, a dynamic annealing strategy is triggered, and the system moves a starting break point forward to a “fill in reimbursement amount” page (an 18th step). By analogy, it gradually steps backward until the model can completely autonomously complete an entire process from a 1st step to an end point without relying on historical prompts. This completely solves a cold start problem faced by general-purpose agents when dealing with ultra-long business flows.

FIG. 4 is a schematic diagram according to a third embodiment of the present disclosure. This embodiment provides an agent-based task processing method. As shown in FIG. 4, the method includes:

401, acquiring a GUI task.

402, executing the GUI task using a GUI agent.

Here, the GUI agent is trained using the method of any of the above embodiments.

For example, the GUI task may be input into the GUI agent. Based on a state of a current step (such as a GUI environment screenshot provided by another service), the GUI agent executes an action of the current step. After the action of the current step is executed, a new state may be generated as a state for a next step. Thus, the GUI task may be completed step by step.

In this embodiment, since the above GUI agent has better performance, a success rate of executing the GUI task based on the GUI agent can be improved.

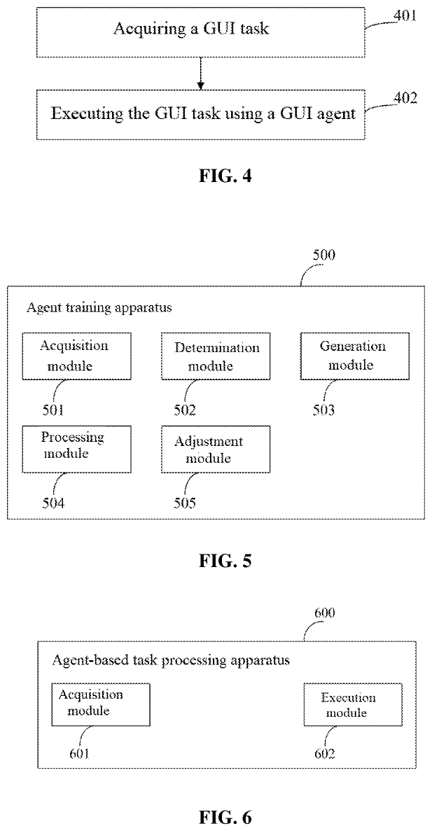

FIG. 5 is a schematic diagram according to a fourth embodiment of the present disclosure. This embodiment provides an agent training apparatus. As shown in FIG. 5, the apparatus 500 includes: an acquisition module 501, a determination module 502, a generation module 503, a processing module 504, and an adjustment module 505.

The acquisition module 501 is configured to acquire a trajectory sample of a target task, the trajectory sample including sample pairs of a plurality of steps, each sample pair of a step including: a GUI environment state and a GUI interaction action; the determination module 502 is configured to determine a starting step among the plurality of steps, where the starting step and a current iteration number are in an inverse mapping relationship; the generation module 503 is configured to acquire, from the GUI environment states, a starting state corresponding to the starting step, and generate a prompt based on the starting state; the processing module 504 is configured to process the prompt using an agent to obtain a truncated trajectory corresponding to the starting state; and the adjustment module 505 is configured to execute, based on the truncated trajectory, a model parameter adjustment process of the agent for the current iteration number.

In this embodiment, by determining a starting step, and the starting step and a current iteration number are in an inverse mapping relationship, a usual exploration from the beginning can be converted to recursion from a tail. That is, assuming a trajectory has a total of 20 steps, exploration may start from a 19th step in a first iteration round, and from an earlier step, such as a 16th step, in a second iteration round. Thus, in early training, since fewer steps need to be explored, it is easy to obtain an exploration trajectory that succeeds in a task, avoiding problems such as model training stagnation caused by a sparse reward mechanism, facilitating learning of effective policies, thereby improving agent performance, such as increasing a success rate of the agent for GUI tasks.

In some embodiments, the determination module 502 is further configured to:
determine the starting step based on current information using a preset mapping function; the current information including the current iteration number, and the mapping function characterizing an inverse mapping relationship between the starting step and the current information.

In this embodiment, using the preset mapping function to determine the starting step based on the current information allows for a simple and efficient determination of the starting step.

In some embodiments, the current information further includes:
a historical success rate of the target task.

In this embodiment, determining the starting step based on the current iteration number and the historical success rate of the target task enables dynamic determination of the starting step, which is more flexible and accurate; based on the inverse mapping relationship described above, a smooth transition of training difficulty can be achieved, such that as capabilities of an agent improve, a number of steps it needs to explore autonomously can be automatically lengthened, until it can independently complete an entire task from s₁ to s_{T}.

In some embodiments, the determination module 502 is further configured to:
determine a negative exponent corresponding to a product of the current iteration number and the historical success rate;
determine a starting ratio based on a preset initial ratio and the negative exponent; and
determine the starting step based on the starting ratio and a total number of steps of the plurality of steps.

Thus, through the above operations, the starting step may be efficiently determined based on the current iteration number and the historical success rate.

In some embodiments, the generation module 503 is further configured to:
acquire, from the GUI interaction actions, a historical action sequence corresponding to the starting state; and
generate the prompt based on the starting state and the historical action sequence.

In this embodiment, by including the starting state and the historical action sequence in the prompt, dual prompting is achieved. By providing the historical action sequence to an agent, exploration steps of the agent in early training can be reduced, allowing the agent to obtain more reference information, effectively alleviating a sparse reward problem caused by long sequence tasks.

In some embodiments, the generation module 503 is further configured to:
compose GUI interaction actions of all steps before the starting step into the historical action sequence.

Thus, when exploring, an agent may refer to the historical action sequence, which provides more historical information for the agent and is beneficial for improving an exploration capability of the agent.

In some embodiments, the generation module 503 is further configured to:
add the target task, the starting state, and the historical action sequence to a prompt template to generate the prompt.

Thus, by pre-configuring a template, the prompt may be generated simply and efficiently.

In some embodiments, the processing module 504 is further configured to:
input the prompt into an agent; and
execute, by the agent, the target task based on the prompt to output a truncated trajectory.

Thus, the agent can explore according to the prompt to obtain the truncated trajectory.

In some embodiments, the truncated trajectory includes:
trajectory points between the starting step and a terminal step, the trajectory points including: a predicted state and a predicted action.

Thus, an agent can start from the starting step, explore actions of subsequent steps, and then perform subsequent training based on a truncated trajectory obtained from this exploration process, improving a learning capability of the agent.

In some embodiments, the processing module 504 is further configured to:
using an agent to control a plurality of environment replicas in parallel based on a prompt, to generate a plurality of truncated trajectories in parallel in the plurality of environment replicas.

In this embodiment, based on the inverse mapping relationship and multiple truncated trajectories described above, a high success rate interval can be actively constructed, thereby completely breaking a “reward collapse” dilemma and forcibly creating reward variance within a group. This allows a GRPO algorithm to obtain clear gradient directions (i.e., knowing which small action differences at a current truncation point determine final success or failure) at any stage of training, achieving efficient credit assignment for key actions and improving training effectiveness.

In some embodiments, the adjustment module 505 is further configured to:
construct an objective function based on a truncated trajectory; and
adjust model parameters based on the objective function.

Thus, training an agent through the objective function can be achieved, improving agent performance.

In some embodiments, the adjustment module 505 is further configured to:
construct an error loss based on a truncated trajectory and a trajectory sample;
acquire a credit value based on the error loss; and
construct an objective function based on the credit value.

Thus, through the above objective function, an agent can be facilitated to learn more effective policies.

In some embodiments, the credit value includes: an advantage value obtained based on a PPO algorithm or a GRPO algorithm.

Thus, by using an advantage value obtained based on a PPO algorithm or a GRPO algorithm, the PPO algorithm or the GRPO algorithm may be used for reinforcement learning of an agent.

FIG. 6 is a schematic diagram according to a fifth embodiment of the present disclosure. This embodiment provides an agent-based task processing apparatus. As shown in FIG. 6, the apparatus 600 includes: an acquisition module 601 and an execution module 602.

The acquisition module 601 is configured to acquire a GUI task; the execution module 602 is configured to execute the GUI task using a GUI agent; where the GUI agent is trained using the method of any of the above embodiments.

In this embodiment, since the above GUI agent has better performance, a success rate of executing the GUI task based on the GUI agent can be improved.

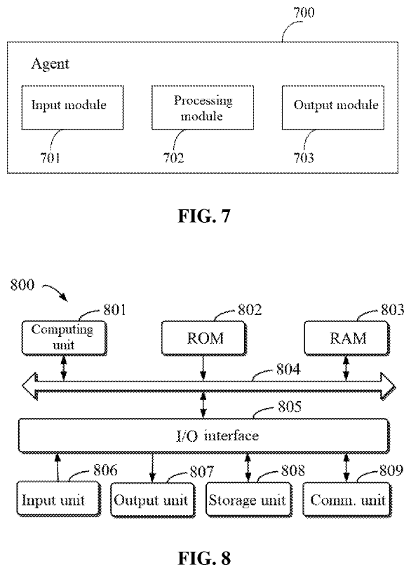

FIG. 7 is a schematic diagram according to a sixth embodiment of the present disclosure. This embodiment provides an agent. As shown in FIG. 7, the agent 700 includes: an input module 701, a processing module 702, and an output module 703.

The input module 701 is configured to acquire a GUI task; the processing module 702 is configured to process the GUI task to obtain a task processing result; and the output module 703 is configured to output the task processing result; where the agent is trained using the method of any of the above embodiments.

For example, a GUI task may be input into a GUI agent. Based on a state of a current step (such as a GUI environment screenshot provided by another service), the GUI agent executes an action of the current step. After the action of the current step is executed, a new state may be generated as a state for a next step. Thus, the GUI task may be completed step by step, obtaining a processing result of the GUI task, such as success or failure. Afterwards, the task processing result may be provided as feedback to a user, or actions of each step may also be provided as feedback to the user.

In this embodiment, since the above GUI agent has better performance, a success rate of executing a GUI task based on the GUI agent can be improved.

It can be understood that in the embodiments of the present disclosure, identical or similar content in different embodiments may be referred to each other.

It can be understood that terms such as “first”, “second” in the embodiments of the present disclosure are only used for distinguishing and do not indicate a degree of importance, temporal order, etc.

It can be understood that if a sequence of steps involved in a process is not specifically limited, it indicates no limitation on a temporal order relationship between these steps.

In the technical solution of the present disclosure, any type of information involved, such as user personal information, is collected, stored, used, processed, transmitted, provided, and disclosed in compliance with relevant laws and regulations and does not violate public policy.

According to embodiments of the present disclosure, the present disclosure further provides an electronic device, a readable storage medium, and a computer program product.

FIG. 8 shows a schematic block diagram of an example electronic device 800 that can be used to implement embodiments of the present disclosure. The electronic device 800 is intended to represent various forms of digital computers, such as laptop computers, desktop computers, workstations, servers, blade servers, mainframe computers, and other suitable computers. The electronic device may also represent various forms of mobile devices, such as personal digital assistants, cellular phones, smart phones, wearable devices, and other similar computing devices. The components shown herein, their connections and relationships, and their functions are merely examples and are not intended to limit implementations of the present disclosure described and/or claimed herein.

As shown in FIG. 8, the electronic device 800 includes a computing unit 801, which may perform various appropriate actions and processes according to a computer program stored in a read-only memory (ROM) 802 or a computer program loaded from a storage unit 808 into a random access memory (RAM) 803. In the RAM 803, various programs and data required for an operation of the electronic device 800 may also be stored. The computing unit 801, the ROM 802, and the RAM 803 are connected to each other via a bus 804. An input/output (I/O) interface 805 is also connected to the bus 804.

Multiple components in the electronic device 800 are connected to the I/O interface 805, including: an input unit 806, such as a keyboard, a mouse; an output unit 807, such as various types of displays, speakers; a storage unit 808, such as a magnetic disk, an optical disk; and a communication unit (comm. unit) 809, such as a network card, a modem, a wireless communication transceiver. The communication unit 809 allows the electronic device 800 to exchange information/data with other devices via a computer network such as the Internet and/or various telecommunications networks.

The computing unit 801 may be various general-purpose and/or special-purpose processing components having processing and computing capabilities. Some examples of the computing unit 801 include, but are not limited to, a central processing unit (CPU), a graphics processing unit (GPU), various special-purpose artificial intelligence (AI) computing chips, various computing units running machine learning model algorithms, a digital signal processor (DSP), and any appropriate processor, controller, microcontroller, etc. The computing unit 801 performs various methods and processes described above, such as an agent training method or an agent-based task processing method. For example, in some embodiments, the agent training method or the agent-based task processing method may be implemented as a computer software program tangibly embodied in a machine-readable medium, such as the storage unit 808. In some embodiments, part or all of a computer program may be loaded and/or installed onto the electronic device 800 via the ROM 802 and/or the communication unit 809. When the computer program is loaded into the RAM 803 and executed by the computing unit 801, one or more steps of the agent training method or the agent-based task processing method described above may be performed. Alternatively, in other embodiments, the computing unit 801 may be configured to execute the agent training method or the agent-based task processing method by any other suitable means (e.g., by means of firmware).

Various implementations of the systems and techniques described herein above may be implemented in digital electronic circuit systems, integrated circuit systems, field programmable gate arrays (FPGAs), application-specific integrated circuits (ASICs), application-specific standard products (ASSPs), systems on a chip (SOCs), complex programmable logic devices (CPLDs), computer hardware, firmware, software, and/or combinations thereof. These various implementations may include: being implemented in one or more computer programs that are executable and/or interpretable on a programmable system including at least one programmable processor, the programmable processor may be a special-purpose or general-purpose programmable processor, receiving data and instructions from a storage system, at least one input device, and at least one output device, and transmitting data and instructions to the storage system, the at least one input device, and the at least one output device.

Program codes for implementing a method of the present disclosure may be written in any combination of one or more programming languages. These program codes may be provided to a processor or controller of a general-purpose computer, a special-purpose computer, or other programmable data processing apparatus, such that the program codes, when executed by the processor or controller, cause functions/operations specified in flowcharts and/or block diagrams to be implemented. The program codes may be executed entirely on a machine, partly on a machine, as a stand-alone software package partly on a machine and partly on a remote machine, or entirely on a remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of a machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

To provide interaction with a user, the systems and techniques described herein may be implemented on a computer having: a display device for displaying information to the user (e.g., a CRT (cathode ray tube) or LCD (liquid crystal display) monitor); and a keyboard and a pointing device (e.g., a mouse or a trackball) through which the user may provide input to the computer. Other types of devices may also be used to provide interaction with a user; for example, feedback provided to the user may be any form of sensory feedback (e.g., visual feedback, auditory feedback, or tactile feedback); and input from the user may be received in any form (including acoustic input, voice input, or tactile input).

The systems and techniques described herein may be implemented in a computing system that includes a back-end component (e.g., as a data server), or a computing system that includes a middleware component (e.g., an application server), or a computing system that includes a front-end component (e.g., a user computer having a graphical user interface or a web browser through which a user may interact with implementations of the systems and techniques described herein), or a computing system that includes any combination of such back-end, middleware, or front-end components. The components of a system may be interconnected by any form or medium of digital data communication (e.g., a communication network). Examples of communication networks include: a local area network (LAN), a wide area network (WAN), and the Internet.

A computer system may include a client and a server. The client and server are generally remote from each other and typically interact through a communication network. A relationship of client and server arises by virtue of computer programs running on respective computers and having a client-server relationship with each other. A server may be a cloud server, also referred to as a cloud computing server or a cloud host, which is a host product in a cloud computing service system, solving problems of high management difficulty and weak business scalability existing in traditional physical hosts and VPS services (“Virtual Private Server”, or “VPS” for short). The server may also be a server of a distributed system, or a server incorporating blockchain.

It should be understood that various forms of processes shown above may be used with steps reordered, added, or deleted. For example, the steps described in the present disclosure may be performed in parallel, sequentially, or in a different order as long as a desired result of a technical solution disclosed in the present disclosure can be achieved. No limitation is imposed herein.

The above specific implementation does not constitute a limitation on a protection scope of the present disclosure. It should be understood by those skilled in the art that various modifications, combinations, sub-combinations, and substitutions may be made according to design requirements and other factors. Any modifications, equivalent substitutions, and improvements made within the spirit and principle of the present disclosure shall be included within the protection scope of the present disclosure.

What is claimed is:

1. An agent training method, comprising:
acquiring a trajectory sample of a target task, the trajectory sample comprising samples of a plurality of steps, each sample of a step comprising: a Graphical User Interface, GUI, environment state and a GUI interaction action;
determining a starting step among the plurality of steps, wherein the starting step and a current iteration number are in an inverse mapping relationship;
acquiring, from the GUI environment states, a starting state corresponding to the starting step, and generating a prompt based on the starting state;
processing the prompt using an agent to obtain a truncated trajectory corresponding to the starting state; and
executing, based on the truncated trajectory, a model parameter adjustment process of the agent for the current iteration number.

2. The method according to claim 1, wherein determining the starting step among the plurality of steps comprises:
determining the starting step based on current information using a preset mapping function; the current information comprising the current iteration number, and the mapping function characterizing the inverse mapping relationship between the starting step and the current information.

3. The method according to claim 2, wherein the current information further comprises:
a historical success rate of the target task.

4. The method according to claim 3, wherein determining the starting step based on the current information using the preset mapping function comprises:
determining a negative exponent corresponding to a product of the current iteration number and the historical success rate;
determining a starting ratio based on a preset initial ratio and the negative exponent; and
determining the starting step based on the starting ratio and a total number of steps of the plurality of steps.

5. The method according to claim 1, wherein generating the prompt based on the starting state comprises:
acquiring, from the GUI interaction actions, a historical action sequence corresponding to the starting state; and
generating the prompt based on the starting state and the historical action sequence.

6. The method according to claim 5, wherein acquiring the historical action sequence comprises:
composing the GUI interaction actions of all steps before the starting step into the historical action sequence.

7. The method according to claim 5, wherein generating the prompt based on the starting state and the historical action sequence comprises:
adding the target task, the starting state, and the historical action sequence to a prompt template to generate the prompt.

8. The method according to claim 5, wherein processing the prompt using the agent to obtain the truncated trajectory corresponding to the starting state comprises:
inputting the prompt into the agent; and
using the agent to execute the target task based on the prompt to output the truncated trajectory.

9. The method according to claim 8, wherein the truncated trajectory comprises:
trajectory points between the starting step and a terminal step, the trajectory points comprising: a predicted state and a predicted action.

10. The method according to claim 1, wherein processing the prompt using the agent to obtain the truncated trajectory corresponding to the starting state comprises:
using the agent to control a plurality of environment replicas in parallel based on the prompt, to generate a plurality of truncated trajectories in parallel in the plurality of environment replicas.

11. The method according to claim 1, wherein executing, based on the truncated trajectory, the model parameter adjustment process of the agent for the current iteration number comprises:
constructing an objective function based on the truncated trajectory; and
adjusting model parameters based on the objective function.

12. The method according to claim 11, wherein constructing the objective function based on the truncated trajectory comprises:
constructing an error loss based on the truncated trajectory and the trajectory sample;
acquiring a credit value based on the error loss; and
constructing the objective function based on the credit value.

13. The method according to claim 12, wherein the credit value comprises: an advantage value obtained based on a Proximal Policy Optimization, PPO, algorithm or a Group Relative Policy Optimization, GRPO, algorithm.

14. An agent, comprising:
an input module configured to acquire a Graphical User Interface, GUI, task;
a processing module configured to process the GUI task to obtain a task processing result; and
an output module configured to output the task processing result;
wherein the agent is trained by:
acquiring a trajectory sample of a target task, the trajectory sample comprising samples of a plurality of steps, each sample of a step comprising: a GUI environment state and a GUI interaction action;
determining a starting step among the plurality of steps, wherein the starting step and a current iteration number are in an inverse mapping relationship;
acquiring, from the GUI environment states, a starting state corresponding to the starting step, and generating a prompt based on the starting state;
processing the prompt using the agent to obtain a truncated trajectory corresponding to the starting state; and
executing, based on the truncated trajectory, a model parameter adjustment process of the agent for the current iteration number.

15. An electronic device, comprising:
at least one processor; and
a memory communicatively connected to the at least one processor; wherein, the memory stores instructions executable by the at least one processor to cause at least one processor to perform an agent training method, comprising:
acquiring a trajectory sample of a target task, the trajectory sample comprising samples of a plurality of steps, each sample of a step comprising: a Graphical User Interface, GUI, environment state and a GUI interaction action;
determining a starting step among the plurality of steps, wherein the starting step and a current iteration number are in an inverse mapping relationship;
acquiring, from the GUI environment states, a starting state corresponding to the starting step, and generating a prompt based on the starting state;
processing the prompt using an agent to obtain a truncated trajectory corresponding to the starting state; and
executing, based on the truncated trajectory, a model parameter adjustment process of the agent for the current iteration number.

16. The electronic device according to claim 15, wherein determining the starting step among the plurality of steps comprises:
determining the starting step based on current information using a preset mapping function; the current information comprising the current iteration number, and the mapping function characterizing the inverse mapping relationship between the starting step and the current information.

17. The electronic device according to claim 16, wherein the current information further comprises:
a historical success rate of the target task.

18. The electronic device according to claim 17, wherein determining the starting step based on the current information using the preset mapping function comprises:
determining a negative exponent corresponding to a product of the current iteration number and the historical success rate;
determining a starting ratio based on a preset initial ratio and the negative exponent; and
determining the starting step based on the starting ratio and a total number of steps of the plurality of steps.

19. The electronic device according to claim 15, wherein generating the prompt based on the starting state comprises:
acquiring, from the GUI interaction actions, a historical action sequence corresponding to the starting state; and
generating the prompt based on the starting state and the historical action sequence.

20. The electronic device according to claim 19, wherein acquiring the historical action sequence comprises:
composing the GUI interaction actions of all steps before the starting step into the historical action sequence.
